(19) United States
(12) Patent Application Publication
(10) Pub. No.: US 2018/0052729 A1
(43) Pub. Date: Feb. 22, 2018

(54) MANAGEMENT COMPUTER AND COMPUTER SYSTEM MANAGEMENT METHOD

(71) Applicant: HITACHI, LTD., Tokyo (JP)

(72) Inventor: Nobuaki OZAKI, Tokyo (JP)

(73) Assignee: HITACHI, LTD., Tokyo (JP)

(21) Appl. No.: 15/554,123

(22) PCT Filed: Aug. 7, 2015
(86) PCT No.: PCT/JP2015/072562

§ 371 Date: Aug. 28, 2017

(51) Int. Cl. G06F 11/07

(52) U.S. Cl. CPC G06F 11/0793; G06F 11/0721

(57) ABSTRACT

Provided is a management computer that has a processor, an input device, an output device, and a storage device, and manages a plurality of computer systems. This management computer is provided with a countermeasure procedure plan generation module that generates a countermeasure procedure plan for changing the state of parts of the plurality of computer systems. This countermeasure procedure plan generation module generates a countermeasure procedure plan according to a constraint in which among the plurality of computer systems or parts thereof, the effect on higher-ranking computer systems or the parts thereof is smaller than the effect on lower-ranking computer systems or the parts thereof.

### TECHNICAL FIELD

The present invention relates to management of a computer system, and relates to a management computer, a management method of a computer system, and related art.

### BACKGROUND ART

Heretofore, a management system that proposes recommended countermeasures so as to assist judgement of an administrator when a problem occurs in a computer system is disclosed (for example, refer to the following Patent Literature 1). The management system disclosed in Patent Literature 1 generates concrete countermeasures on the basis of a rule for handling a problem with mainly referring to operational data such as disk operating ratio, evaluates the effect, and presents the administrator. Hereby, the administrator can readily judge or select the concrete countermeasures for solving the problem of the computer system.

### CITATION LIST

### Patent Literature

Patent Literature 1: WO 2014/073045

### SUMMARY OF INVENTION

### Technical Problem

However, the abovementioned Patent Literature 1 lacks processing for considering referring to operating policy including a degree of importance of parts configuring the computer system such as a virtual server, a logical volume, and the like and priority of customers. Therefore, the countermeasures recommended in Patent Literature 1 may have harmful influence on a more important element such as an important customer.

For example, to generate a countermeasure for transferring a virtual machine from a certain host server to another host server, such a countermeasure that a virtual machine utilized by an important customer is selected as an object of transfer though a virtual machine having a relatively low degree of importance such as a virtual machine for experiment exists is generated. An administrator of a computer system has a subject that the administrator should verify details of a countermeasure so as to prevent an important virtual machine from having harmful influence by execution of the countermeasure and if necessary, should correct the countermeasure.

### Solution to Problem

A computer system as one aspect of the present invention disclosed in this application holds information related to operating policy for every customer and every part configuring the computer system, sorts a range on which a countermeasure has influence on the basis of the operating policy when the countermeasure for a problem is generated, and generates a countermeasure so that influence on a high order customer is smaller than influence on a low order customer. For example, the countermeasure has only to be realized by performing such operation that high order customers are excluded from an object of operation for the countermeasure or that high order customers receive smaller influence on performance. The generated countermeasure may be handled in a manner that an administrator operates it, a management computer presents candidates of a countermeasure to the administrator and the management computer executes the generated countermeasure after approval of the administrator, and the management computer automatically executes the generated countermeasure on the basis of prior approval, a result of learning, and the like.

Another aspect of the present invention in this application relates to a management computer provided with a processor, an input device, an output device, and a storage for managing plural computer systems. This management computer is provided with a countermeasure procedure plan generation module that generates countermeasure procedure plans for altering states of parts in plural computer systems. The countermeasure procedure plan generation module generates countermeasure procedure plans according to a constraint that influence on a higher-ranking computer system or its parts out of plural computer systems or their parts is to be below influence on a lower-ranking computer system or its parts.

Further another aspect of the present invention relates to a computer system management method of managing plural computer systems by a management computer provided with a processor, an input device, an output device and a storage. According to this method, the management computer generates a countermeasure procedure plan according to a constraint that influence on a higher-ranking computer system or its parts out of plural computer systems or their parts is to be smaller than influence on a lower-ranking computer system or its parts when the management computer generates the countermeasure procedure plan for altering states of parts of the plural computer systems.

In this case, parts of the computer system include a tenant, a server, a virtual computer, a volume of a storage, and an IO processing unit, and size and classification are arbitrary. The constraint is automatically or manually generated on the basis of operating policy of the computer system for a concrete example. Depending on a case, the constraint may also be the operating policy itself. In addition, definition and a grade of ranking of computer systems or their parts may also be arbitrary.

### Advantageous Effects of Invention

According to representative embodiments of the present invention, the management computer can present a countermeasure having small influence on an important element, for example, a high order customer out of countermeasures that enable settling a problem. Problems, configurations and effects except the abovementioned ones will be clarified according to description of the following embodiments.

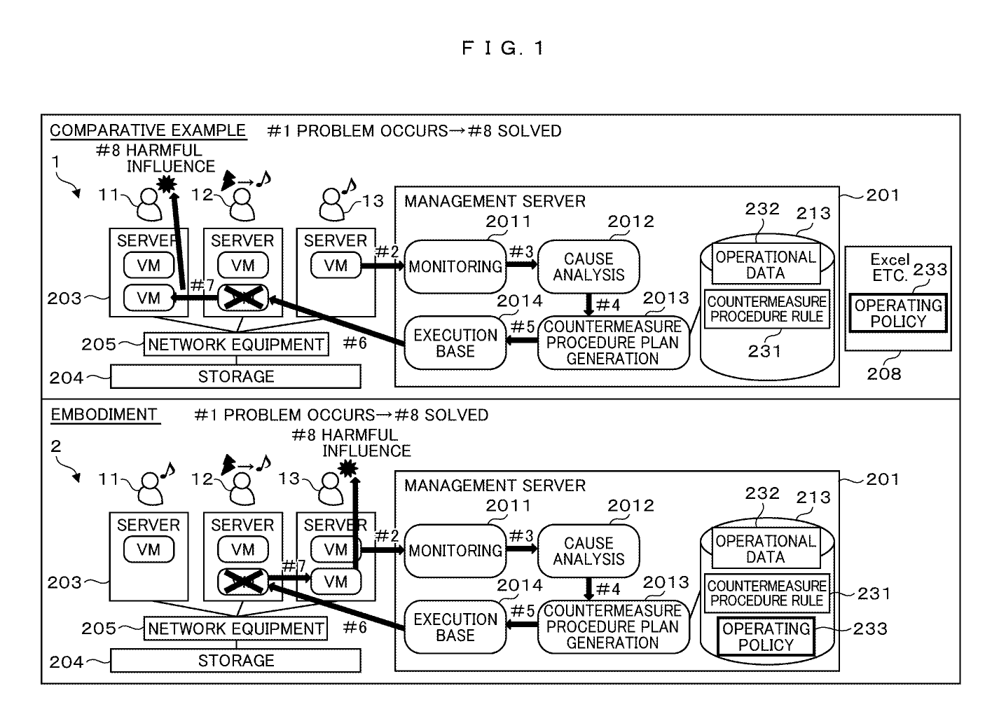

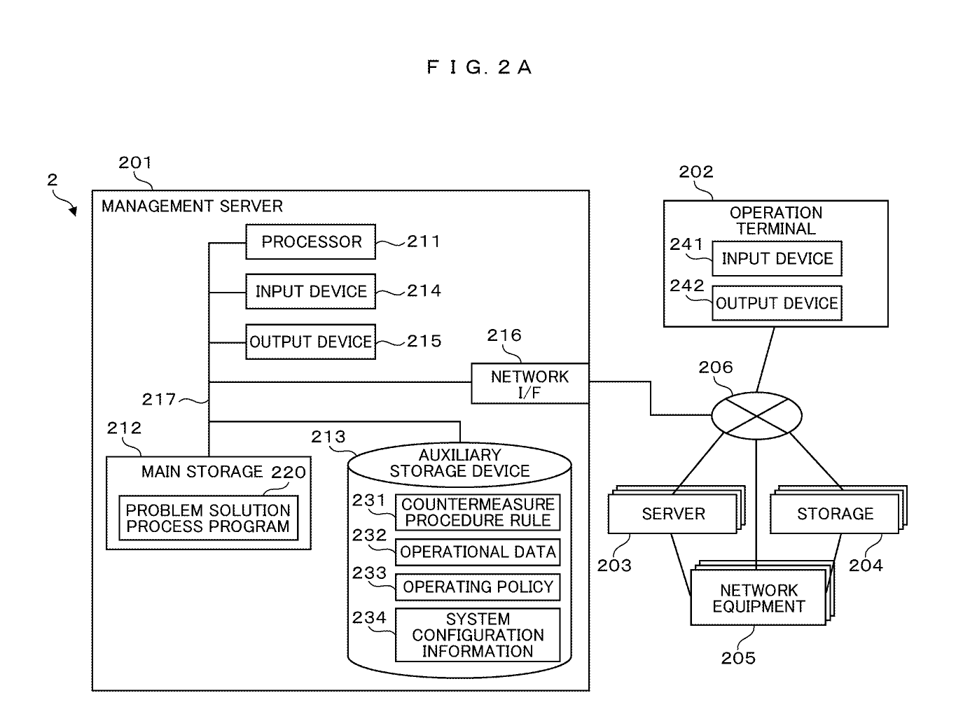

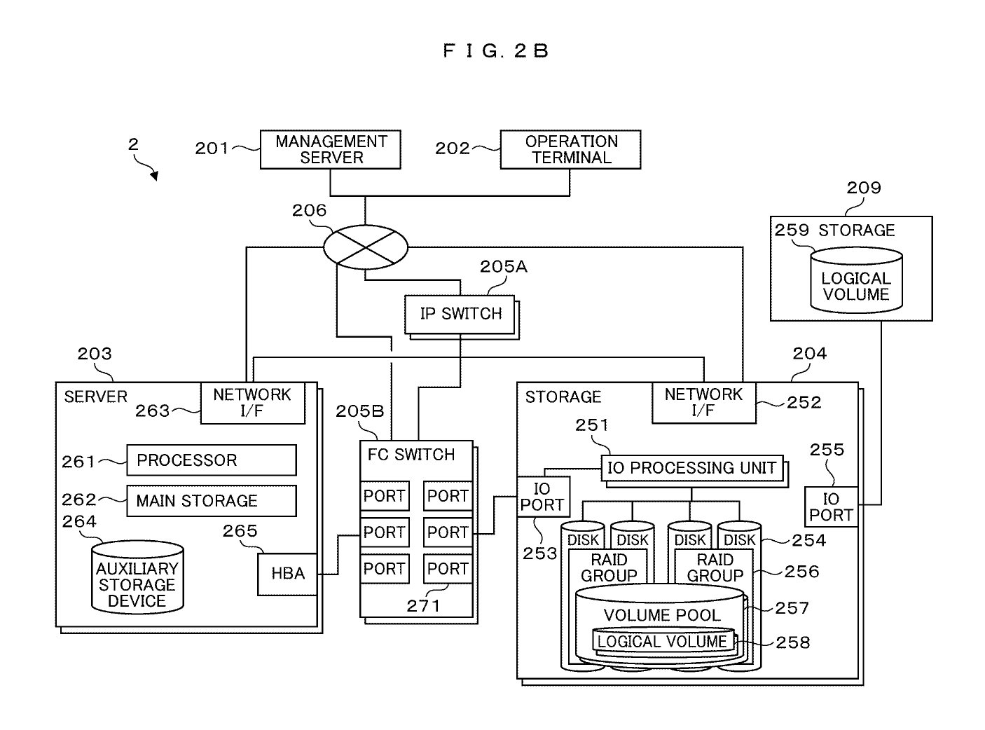

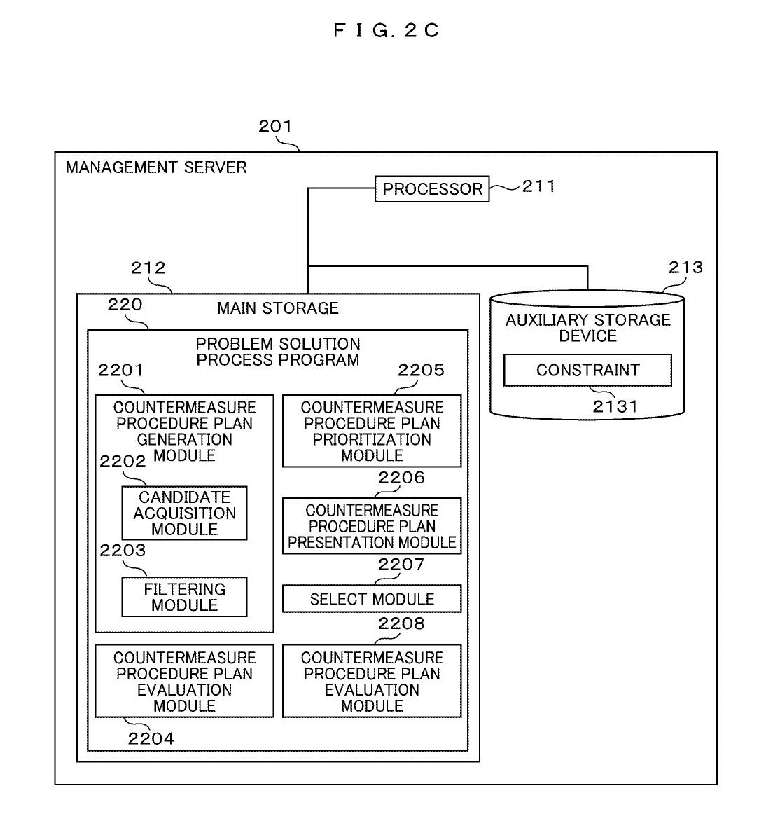

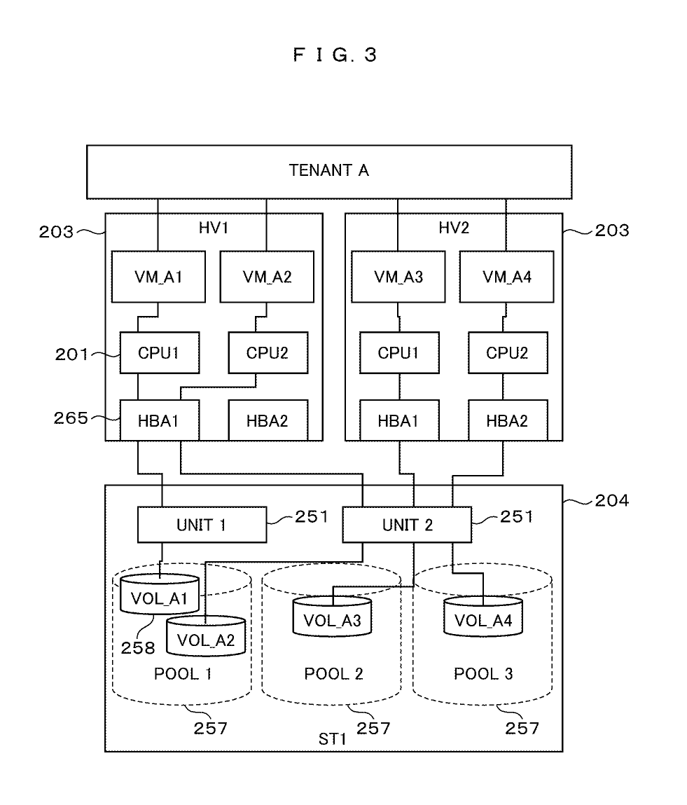

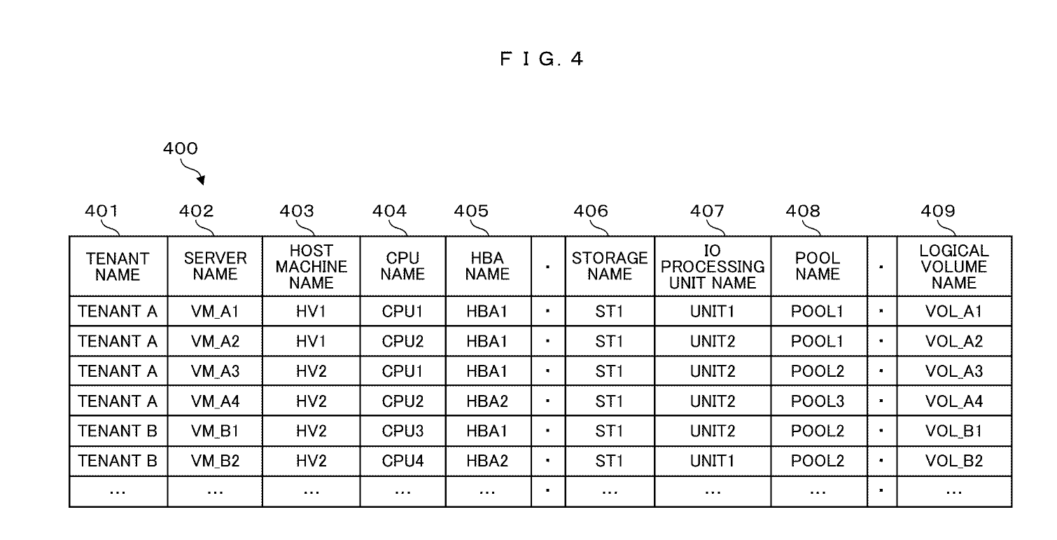

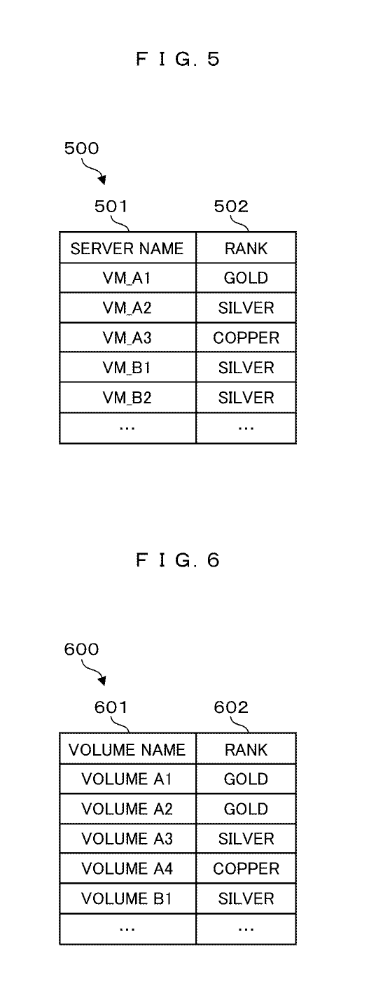

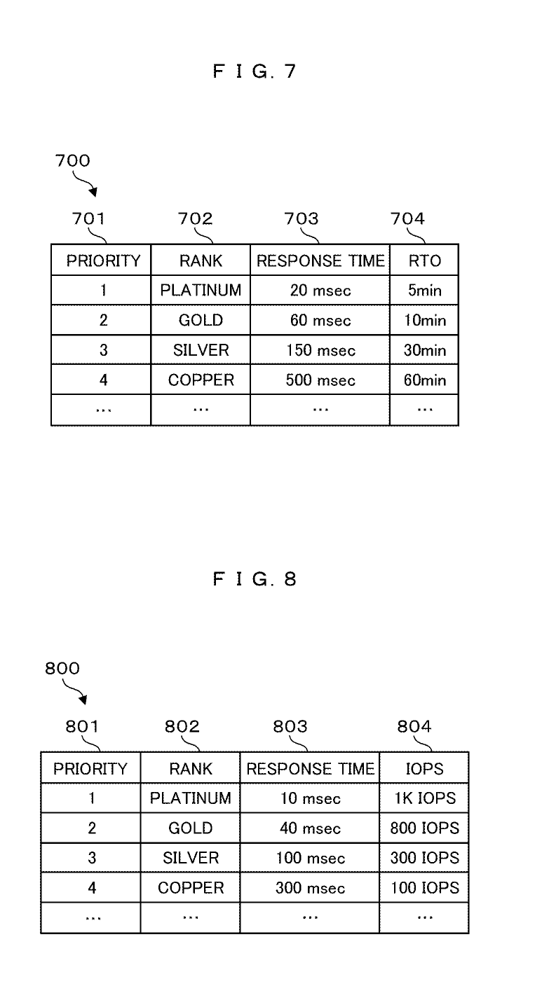

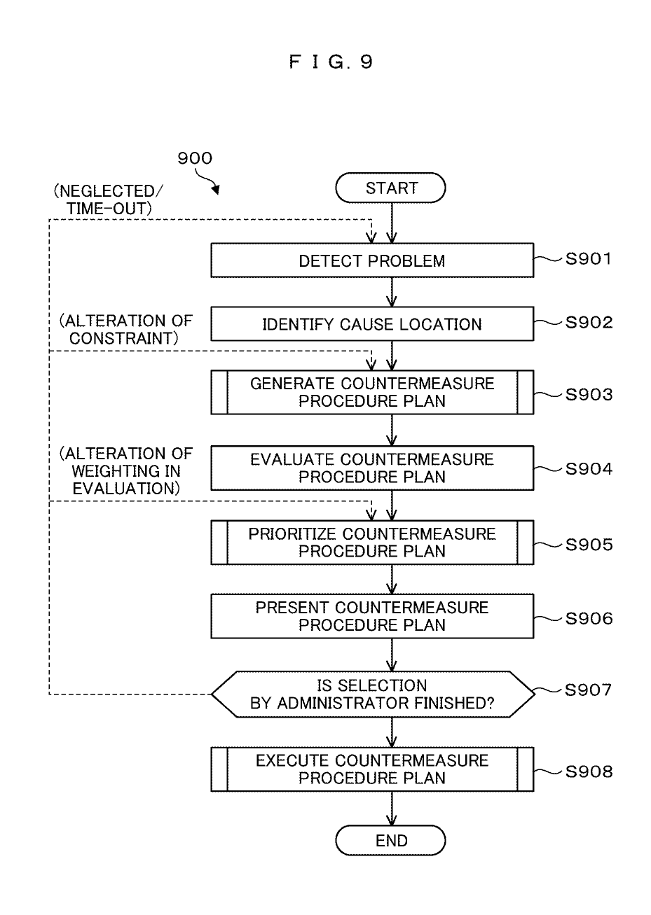

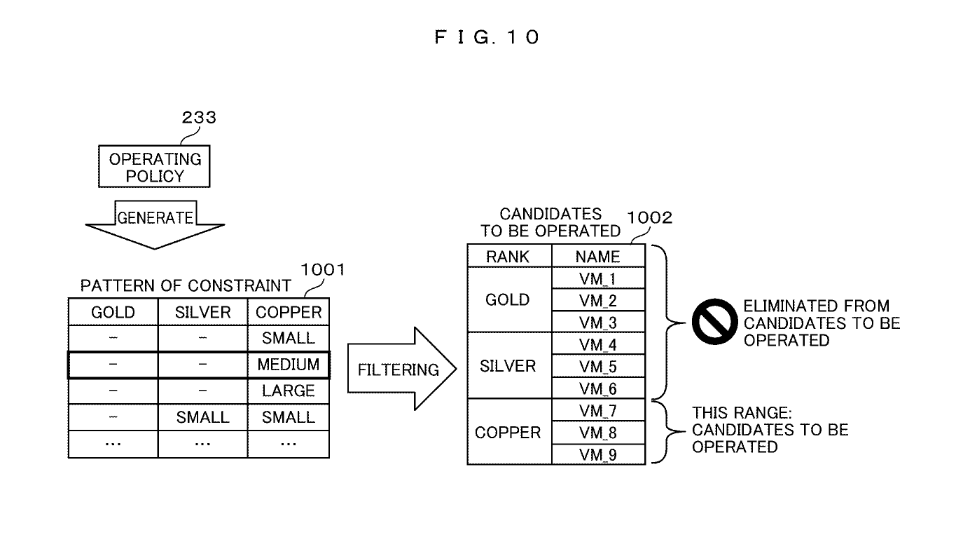

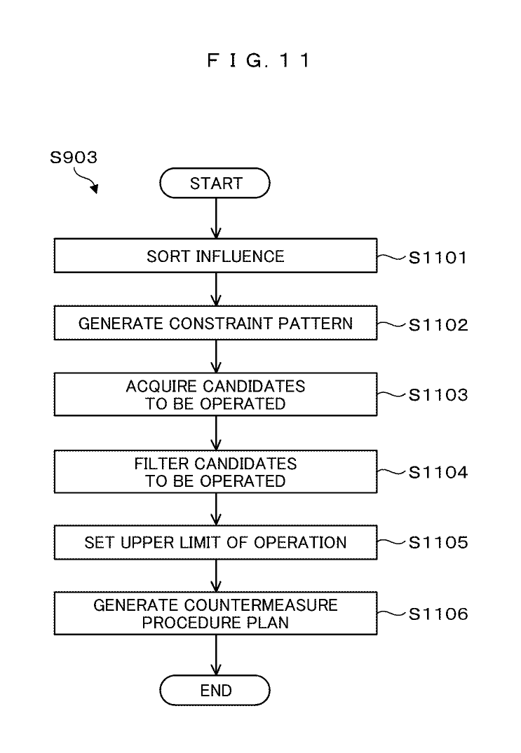

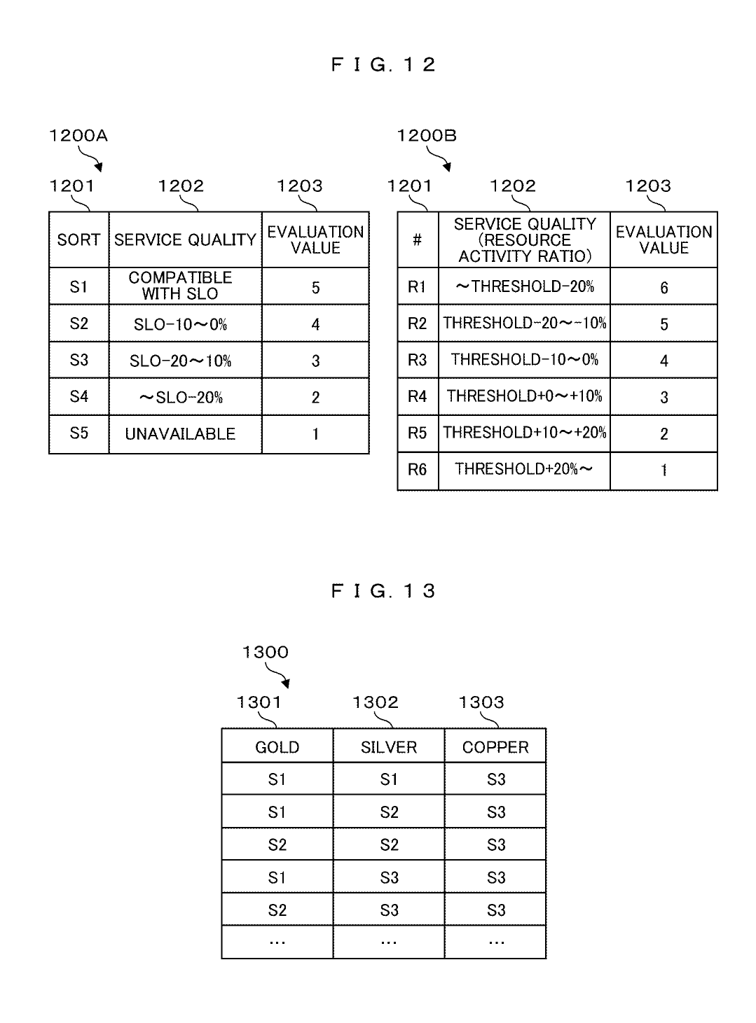

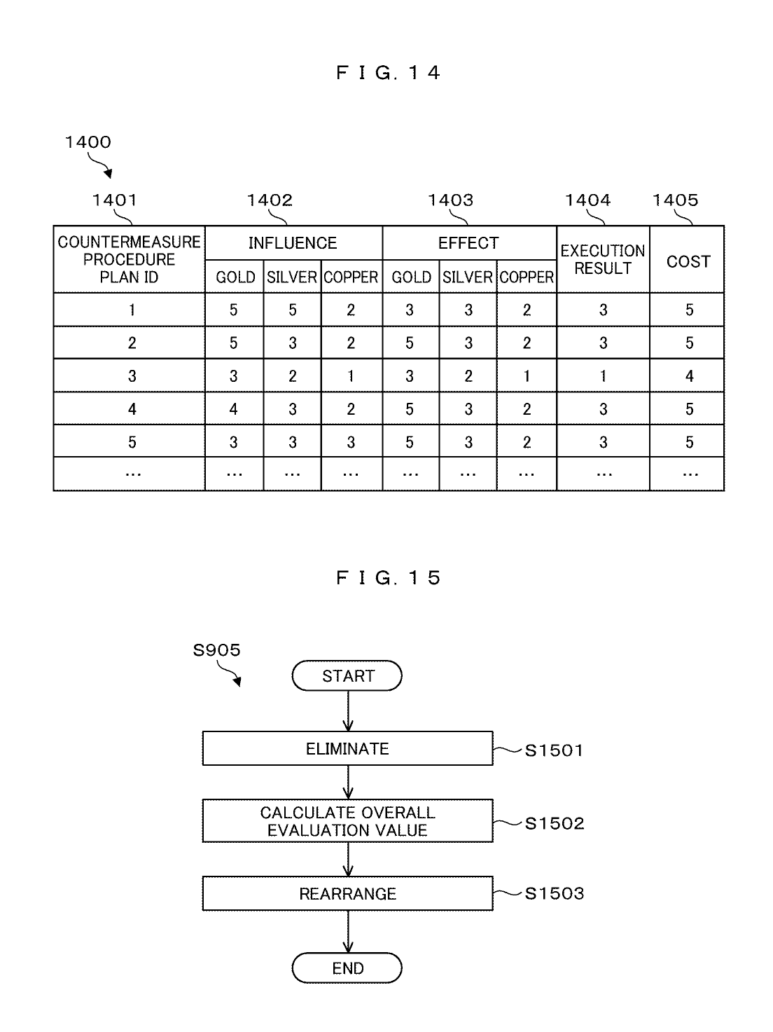

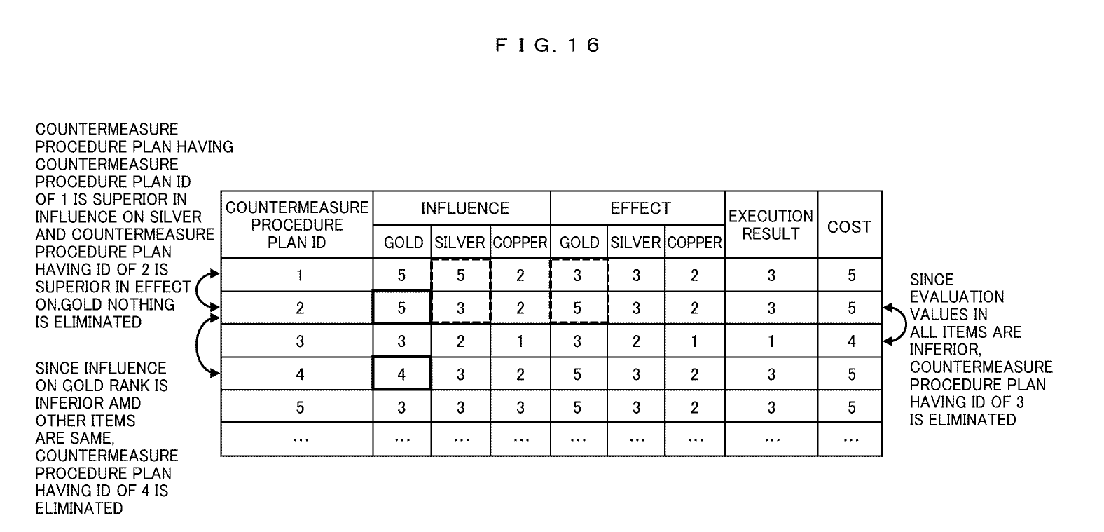

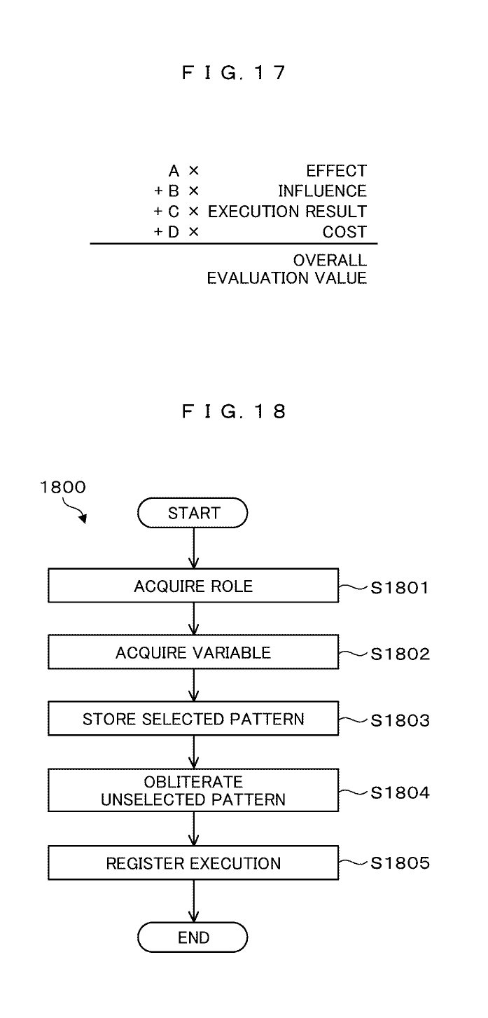

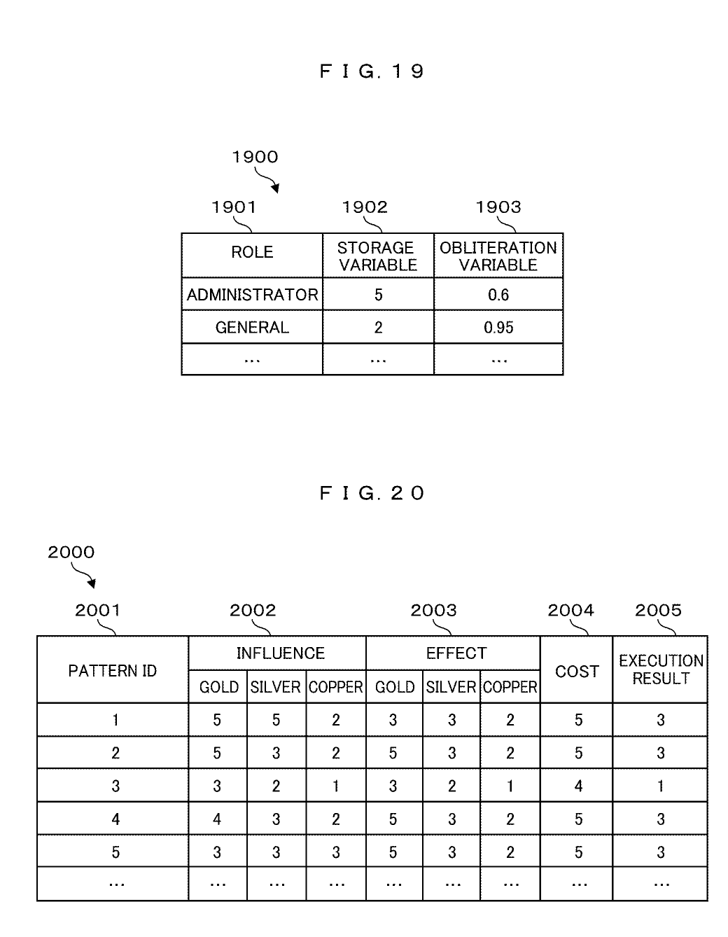

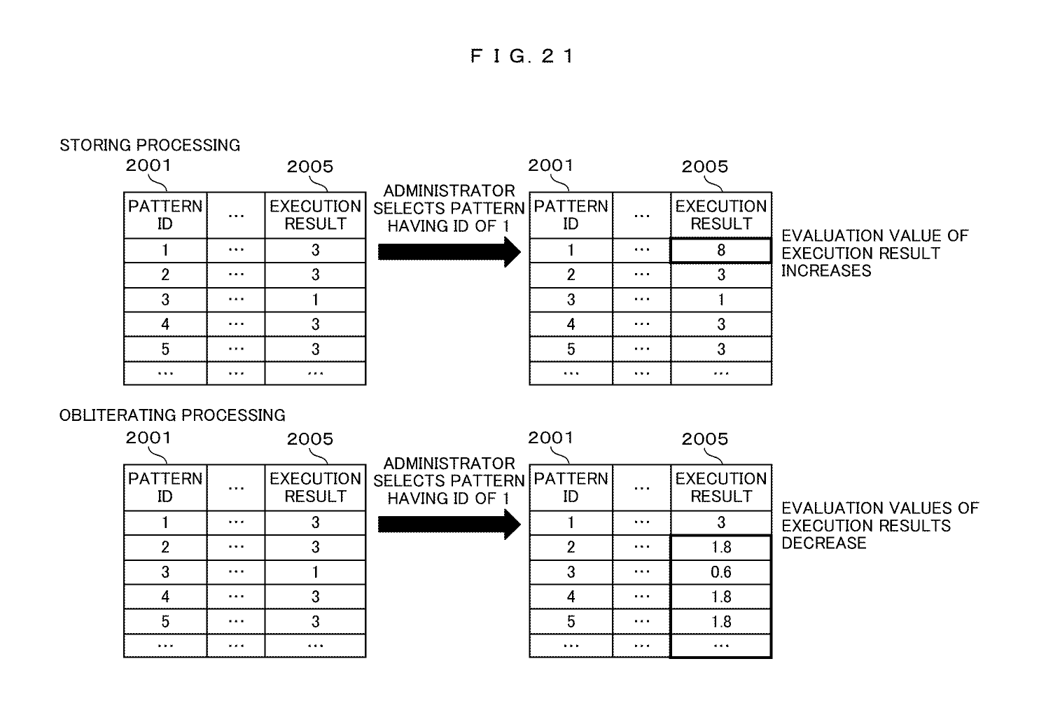

### BRIEF DESCRIPTION OF DRAWINGS

[FIG. 1] A conceptual block diagram for explaining an outline of a problem solution process flow in a computer system according to an embodiment of the present invention.

[FIG. 2A] A block diagram showing an example of a hardware configuration of the computer system 2 in the embodiment shown in FIG. 1 with a management server 201 in the center.

[FIG. 2B] A block diagram showing an example of the hardware configuration of the computer system 2 in the embodiment shown in FIG. 1 with a device group to be managed by the management server 201 in the center.

[FIG. 2C] A block diagram mainly showing functions of the management server 201 in an example of the hardware configuration of the computer system 2 in the embodiment shown in FIG. 1.

[FIG. 3] A block diagram showing one example of a tenant system configured on the computer system 2 shown in FIG. 1.

[FIG. 4] A table showing one example of a topology correspondence table 400 as a part of system configuration information 234.

[FIG. 5] A table showing one example of a server rank table 500 as a part of operating policy information 233.

[FIG. 6] A table showing one example of a volume rank table 600 as a part of the operating policy information 233.

[FIG. 7] A table showing one example of a server rank detailed table 700 as a part of the operating policy information 233.

[FIG. 8] A table showing one example of a volume rank detailed table 800 as a part of the operating policy information 233.

[FIG. 9] A flowchart showing an example of a procedure for a problem solution process 900 by the management server 201.

[FIG. 10] A conceptual diagram showing an example of a countermeasure procedure plan generation step S903 shown in FIG. 9.

[FIG. 11] A flowchart showing an example of a procedure for the countermeasure procedure plan generation step S903 shown in FIG. 9.

[FIG. 12] Tables showing examples of an influence degree sort table 1200.

[FIG. 13] A table showing one example of a constraint pattern table 1300.

[FIG. 14] A table showing one example of countermeasure procedure plan evaluation result table 1400.

[FIG. 15] A flowchart showing an example of a procedure for a countermeasure procedure plan prioritization step S905 shown in FIG. 9.

[FIG. 16] An outline of elimination processing in a case where evaluation results of countermeasure procedure plans are as shown in FIG. 14.

[FIG. 17] An example of a mathematical expression used in an overall evaluation value calculation step S1503 shown in FIG. 15.

[FIG. 18] A flowchart showing an example of a procedure for a countermeasure procedure plan execution step (a step S908) when countermeasure procedure plan execution results executed by the management server 201 are stored.

[FIG. 19] A table showing one example of a variable table 1900.

[FIG. 20] A table showing one example of a pattern table 2000.

[FIG. 21] A conceptual diagram showing variation in values of execution results 2005 when a storing step and an obliterating step are executed.

### DESCRIPTION OF EMBODIMENTS

Information of this embodiment will be described in representation such as an “aaa” table, an “aaa” list, an “aaa” DB (Database) and an “aaa” queue (aaa is an arbitrary character string) below. However, these pieces of information may also be represented except data structure such as a table, a list, DB and a queue. Therefore, to show no dependence upon data structure, the aaa table, the aaa list, the aaa DB and the aaa queue are sometimes called “aaa” information.

In addition, when contents of each information piece are described, representation such as identification information, an identifier, a name and ID (IDentification) is used. However, these can be mutually replaced.

Moreover, the following description may be made using a program for a subject. However, since a program executes determined processing by being executed by a processor using a memory and a communication port (a communication control device), the following description may also be made using the processor for a subject. In addition, processing disclosed using a program for a subject may also be executed by a computer such as a management server and an information processor. Further, a part or the whole of a program may also be realized by dedicated hardware.

Furthermore, various programs may also be installed in each computer by a program distribution server or in the shape of a storage medium readable for the computer. In this case, the program distribution server includes a processor and storage resources, and the storage resources further store a distribution program and programs to be distributed. When the processor executes the distribution program, the processor of the program distribution server distributes a program to be distributed to another computer.

Furthermore, a computer is provided with an input-output device. For examples of the input-output device, a display, a keyboard and a pointing device are conceivable, although the input-output device may also be a device except these. Furthermore, information may also be displayed on a computer for display by using a serial interface and an Ethernet interface in place of the input-output device, connecting the computer for display provided with a display, a keyboard or a pointing device to the corresponding interface, transmitting information for display to the computer for display, and receiving information for input from the computer for display. Input and display may also be made on the input-output device by accepting input.

Hereinafter, a set of one or more computers that manage an information processing system and display information for display in this embodiment is sometimes called a management system. When a computer for management (hereinafter called a management computer) displays information for display, the management computer functions as the management system or a combination of the management computer and the computer for display is also the management system. In addition, for acceleration of processing for management and enhancement of reliability, the similar processing to the management computer may also be realized by plural computers and in this case, the plural computers (also including the computer for display in a case where the computer for display performs display) function as the management system.

A countermeasure in the present invention denotes information including contents of such concrete operation that a virtual machine having ID of 00_1 is migrated to a host machine having ID of 02 and that access to a disk of the virtual machine 00_1 is limited to 1000 IOPS. Hereinafter, an expression such as a countermeasure, a countermeasure plan, an action plan, and the like will be used. In addition, such qualitative information including no contents of concrete operation that a virtual machine is migrated from a certain host machine to another machine and that the number of accesses to a disk of a virtual machine is limited is hereinafter called a countermeasure rule or is merely called a rule.

### First Embodiment

FIG. 1 illustrates an outline of a problem solving process flow in a computer system in this embodiment. Details of the system in this embodiment will be described using a system to which this embodiment is not applied for a comparative example below.

A computer system 1 shows the computer system in the comparative example to which this embodiment is not applied. The computer system 1 is provided with a server 203 to be managed, a storage 204 to be managed, network equipment 205 to be managed, and a management server 201 that manages a group of these devices to be managed. In addition, operating policy 233 as specified values of priority in a tenant system configured an application operated in the device to be managed or an application group operated in the device to be managed and performance is held in an external file 208 such as Excel stored outside the management server 201. As for tenants using the system, such weight as a super-important tenant 11, an important tenant 12, and a normal tenant 13 is applied.

The management server 201 detects a problem (#1) which occurs in the important tenant 12 (#2) by a monitoring function 2011 and analyzes a cause of the problem (#3) by a cause analysis function 2012. A countermeasure procedure plan generation function 2013 generates a countermeasure procedure plan for solving the problem (#4) on the basis of a countermeasure procedure rule 231 and operational data 232 respectively in an auxiliary storage device 213, and the generated countermeasure procedure is executed and registered (#5) by an execution base function 2014. The server 203 (#6) receiving from the management server 201 migrates a virtual machine (described as VM in FIG. 1) operated in the server 203 to another server 203 (#7). Consequently, even if the problem caused in the important tenant 12 can be solved, it may have harmful influence on the super-important tenant 11 (#8).

Normally, it is considered that when a problem occurs in a specific tenant, it should be avoided to have harmful influence on a more important tenant than the tenant having the problem (Hereinafter, the more important tenant will be called a higher-ranking tenant and conversely, a less important tenant will be described a low o ranked tenant). However, in the comparative example, a problem caused in the specific tenant sometimes has harmful influence on the higher-ranking tenant. The reason is that the operating policy 233 held outside the management server is not referred though a countermeasure procedure is generated according to the operational data 232 and the countermeasure procedure rule 231 when the management server generates the countermeasure procedure plan. The countermeasure procedure plan in this case denotes a plan of such a problem solution procedure that VM_1 should be migrated from a server_1 to a server_2. In a countermeasure procedure plan generation process, such various procedure plans that VM_3 is migrated from the server_1 to a server_3 and that an upper limit of requests of a tenant system A is limited from 100 requests/sec to 50 requests/sec are generated, effect and influence are estimated, and priority is applied.

In the system 1 in the comparative example in FIG. 1, since the VM used by the important tenant 12 is migrated to the server having the VM used by the super-important tenant 11, the migration may have influence on the super-important tenant 11.

A computer system 2 illustrates an outline of a computer system in this embodiment. In the system 2, a countermeasure procedure plan is generated in consideration of operating policy and an important tenant is preferred. For one example of a configuration, the computer system 2 stores the operating policy 233 held outside the management server 201 in the computer system 1 in a management server 201 and has the similar system configuration to the system configuration of the computer system 1 except that no external file 208 is included. Although a flow of a process is also similar, the computer system 2 is different from the computer system 1 in that the operating policy 233 is referred in the process for generating the countermeasure procedure plan. Hereby, when a problem caused in the important tenant 12 is solved, a range of harmful influence can be limited to the normal tenant 13 without having harmful influence on the super-important tenant 11.

As described above, this embodiment produces effect by utilizing the operating policy for a constraint in the countermeasure procedure plan generation process and favorably treating higher-ranking tenants. In the system configurations shown in FIG. 1, some of details of system configurations described referring to FIG. 2A and the followings are omitted for simplification of description and some are exaggerated.

FIG. 2A is a block diagram showing a hardware configuration example of the computer system 2 in this embodiment shown in FIG. 1 with the management server 201 in the center. The management server 201 is provided with a processor 211, a main storage 212, an auxiliary storage device 213, an input device 214, an output device 205, and a network I/F 216. The processor 211, the main storage 212, the auxiliary storage device 213, the input device 214, the output device 205, and the network I/F 216 are connected to a bus 217.

The processor 211 executes a problem solving program 220. The problem solving program 220 is software (a program) stored in the main storage 212 such as a semiconductor memory and executes a desired function utilizing hardware resources of the management server 201 such as the processor 211. Processing by the problem solving program 220 may also be realized by hardware such as an integrated circuit in place of execution in the processor 211.

The auxiliary storage device 213 such as a magnetic disk storage stores a countermeasure procedure rule 231, operational data 232, operating policy 233, and system configuration information 234 as data. The countermeasure procedure rule 231, the operational data 232, the operating policy 233, and the system configuration information 234 respectively in the auxiliary storage device 213 may also be stored in different storage devices.

In this case, the countermeasure procedure rule 231 means a processing mode group for generating a procedure for solving a problem caused in the computer system. Examples include a mode in which an arbitrary virtual machine operated in a server is migrated to another arbitrary server when excess of a threshold of CPU activity ratio in the specific server is detected and a mode in which IO volume of a logical volume existing in the disk storage is limited when excess of a threshold of working ratio of storage disks configuring a volume pool in the storage is detected. The countermeasure procedure rule 231 has only to include one or more types processing modes.

The operational data 232 means operational information including a resource usage rate for a fixed period of the computer system and the number of received requests such as CPU activity ratio information of a server 203 for past one month.

The operating policy 233 includes at least either of “priority” or “desired values of performance”. The priority means such a degree of importance as shown as gold, silver, and copper. The priority has only to be such information that gold is more important than silver and that silver is more important than copper for determining superiority or inferiority. In addition, for the desired values of performance, a matter that response time is within 100 milliseconds and a matter that throughput is 100 requests/sec can be given. The abovementioned operating policy may also be held for every virtual machine and every logical volume, is roughly held for every application and every tenant system, and the operating policy may also be held in such a manner that the similar operating policy is applied to all virtual machines configuring the application and the tenant system.

The system configuration information 234 means information for identifying topology in a group of devices to be managed such as the server 203, a storage 204, and network equipment 205 and topology among the tenant system to be managed and the group of devices to be managed.

The auxiliary storage device 213 may also be an external storage such as the storage 204 connected to the management server 201 via an interface (I/F) (not shown) to an external device or the network I/F 216. In addition, the main storage 212 and the auxiliary storage device 203 may also be the same device.

The input device 214 is a device that inputs data according to operation on a keyboard of an administrator. The output device 215 is a device that displays an execution result of the processor 211 such as a printer and a monitor. The input device 214 and the output device 215 may also be integrated.

In addition, an operation terminal 202 may also be connected to the computer system 201. The operation terminal 202 is a computer for operating the management computer 201. The operation terminal 202 is provided with an input device 241 and an output device 242. The input device 241 is a device for inputting data according to operation of the administrator. Input data is transmitted to the management server 201 via a network 206. The output device 242 is a device for displaying data from the management server 201. The input device 241 and the output device 242 may also be integrated.

Moreover, the computer system 2 includes the management server 201, the operation terminal 202, the server 203, the storage 204, and the network equipment 205. The network equipment 205 relays data between each of the management server 201, the operation terminal 202, the server 203, and the storage 204.

FIG. 2B is a block diagram showing the hardware configuration example of the computer system 2 in the first embodiment shown in FIG. 1 with the device group to be managed by the management server 201 in the center. The device group to be managed is a system in which the server 203, the storage 204, and the network equipment 205 are mutually connected via the network 206 and a SAN (Storage Area Network).

The server 203 includes a processor 261, a main storage 262, a network I/F 263, an auxiliary storage device 264, and an HBA (Host Bus Adapter) 365.

The auxiliary storage device 264 may also be an external storage connected via the network I/F 263, the HBA 265, and an interface of an external device not shown. In addition, the server 203 may also be a virtual machine. The server 203 is monitored by the management server 201. The server 203 executes software and a virtual machine respectively configuring the tenant system. The network I/F 263 is connected to another network I/F 252 and an IP (Internet Protocol) switch 205A which is one example of the network equipment 205 via the network 206. The HBA 265 is connected to a port of an FC (Fiber Channel) switch which is one example of the network equipment 205.

The storage 204 is managed by the management server 201 and provides storage capacity used by software operated in the server 203 or the management server 201. The storage 204 is provided with an IO processing unit 251, the network I/F 252, an IO port 253, a DISK 254 and an IO port 255. The DISK 254 may also configure a RAID group 256 by plural DISKs 254. The RAID group 256 may also configure a volume pool 257 by a single or plural RAID groups 256. For example, when the storage 204 is utilized for the auxiliary storage device of the server 203, data in the auxiliary storage device 264 may also be stored in a logical volume 258. The logical volume 258 has only to exist in any of the volume pool 257, the RAID group 256 or the DISK 254.

The network I/F 252 is an interface for connecting to the network 206 such as a LAN (Local Area Network) by Ethernet (registered trademark). The IO port 253 and the IO port 255 are an interface for connecting to the storage area network (SAN) such as a fiber channel. In addition, the storage 204 may also manage a logical volume 259 existing in an external storage 209 connected via the IO port 255.

For the network equipment 205, the IP switch 205A, and an FC switch 205B can be given. The IP switch 205A is connected to the network I/F 216 of the management server 201, the network I/F 263 of the server 203, the network I/F 252 of the storage 204, a network IF not shown of the FC switch 205B, and a network I/F not shown of another IP switch 205B. The FC switch 205B transfers data between the server 203 and the storage 204. The FC switch 205B is provided with plural ports 271. The port 271 of the FC switch 205B is connected to the HBA 265 of the server 203 and the IO port 253 of the storage 204. The network equipment 205 may also be managed by the management server 201.

FIG. 2C is a functional block diagram for explaining a functional configuration example of the management server 201 in the hardware configuration example of the computer system 2 in the first embodiment shown in FIG. 1.

The processor 211 of the management server 201 realizes various functions under control of the problem solving program 220 in the main storage 220. For convenience, a module corresponding to a function is defined in the problem solving program 220. However, these modules are not required to be physically separated. In addition, these modules are not required to correspond to an independent program or a subroutine. The problem solving program 220 is provided with a countermeasure procedure plan generation module 2201. The countermeasure procedure plan generation module 2201 includes a candidate acquisition module 2202 and a filtering module 2203. The problem solving program 220 is further provided with a countermeasure procedure plan evaluation module 2204, a countermeasure procedure plan prioritizing module 2205, a countermeasure procedure plan presentation module 2206, a select module 2207, and a countermeasure procedure plan execution module 2208. Any of these modules may also be omitted and another module may also be added.

The whole of a processing example by the problem solving program 220 will be described referring to FIG. 9 later. A function realized by the countermeasure procedure plan generation module 2201 is equivalent to a step S903 shown in FIG. 9 and details will be described referring to FIG. 11 later. A function realized by the candidate acquisition module 2202 is equivalent to a step S1103 shown in FIG. 11 and acquires a list of candidates as an object of operation for problem solution. A function realized by the filtering module 2203 is equivalent to a step S1104 shown in FIG. 11.

A function realized by the countermeasure procedure plan evaluation module 2204 is equivalent to a step S904 shown in FIG. 9. A function realized by the countermeasure procedure plan prioritizing module 2205 is equivalent to a step S905 shown in FIG. 9 and details will be described referring to FIG. 15 later. A function realized by the countermeasure procedure plan presentation module 2206 is equivalent to a step S906 shown in FIG. 9. A function realized by the select module 2207 is equivalent to a step S907 shown in FIG. 9. A function realized by the countermeasure procedure plan execution module is equivalent to a step S908 shown in FIG. 9.

The main storage 212 or the auxiliary storage device 213 holds constraints 2131 in which the operating policy 233 is reflected. While a part or the whole of the constraints 2131 may also be the same as the operating policy 233, a more concrete rule may also be prepared on the basis of the operating policy 233. The management server 201 itself may also automatically produce the constraints 2131 on the basis of the operating policy 233 according to a program, and the administrator may separately produce the constraints and input them from an external device outside the management server 201. This processing is equivalent to steps S1101 to S1102 shown in FIG. 11. An example of the constraints will be described referring to FIGS. 12 and 13 later.

The abovementioned configuration may also be configured by a single computer or an arbitrary part of the input device, the output device, the processor and the storage may also be configured by another computer connected via the network. In addition, the similar functions to those configured in software can also be realized by hardware such as an FPGA (Field Programmable Gate Array) and an ASIC (Application Specific Integrated Circuit).

FIG. 3 is a block diagram showing one example of the tenant system configured on the computer system 2 shown in FIG. 1. In this case, a tenant A is configured by virtual machines VM_A1 to VM_A4 existing on the server 203 called HV1 and the server 203 called HV2. Each HV1, HV2 which is the server 203 is provided with plural (two in the example in FIG. 3) CPUs 201 and plural (two in the example in FIG. 3) HBAs 265. ST1 which is the storage 204 is provided with plural (two in the example in FIG. 3) IO processing units 251 and plural (three in the example in FIG. 3) volume pools 257.

The virtual machines configuring the tenant A are VM_A1, VM_A2, VM_A3 and VM_A4. The virtual machine VM_A1 is processed in the processor 201 called CPU1 in HV1 and is connected to the storage 204 called ST1 via the HBA 265 called HBA1.

The auxiliary storage device 264 of the VM_A1 is the logical volume 258 processed in the IO processing unit 251 called the unit 1 and called Vol_A1 existing on the volume pool 257 called the pool 1. The VM_A2, the VM_A3, and the VM_A4 also similarly have topology shown in FIG. 3. In FIG. 3, topology of the other components is omitted for simplification of explanation.

FIG. 4 shows one example of a correspondence table 400 including topology included in the system configuration information 234. The system configuration information 234 may also include information not shown such as CPU processing specification information in addition to the topology correspondence table 400.

The correspondence table 400 of the correspondence is information relating the tenant system and system components and is information prepared manually or according to any program beforehand. The topology correspondence table 400 is provided with a tenant name field 401, a server name field 402, a host name field 403, a CPU name field 404, an HBA name field 405, a storage name field 406, an IC processing unit name field 407, a pool name field 408, and a logical volume name field 409. The topology correspondence table 400 may also lack some of these fields, may also include another field not shown, and may also be divided into plural tables.

The tenant name field 401 is an area for storing tenant names. The tenant name is identification information for uniquely identifying the tenant. The server name field 402 is an area for storing names of servers configuring the tenant. The server name is identification information for uniquely identifying the server. The server in this case may also be a physical server and may also be a virtual machine. The following each field 403 to 409 is identifier information for uniquely identifying a component having the topology.

Next, one example of the abovementioned operating policy information 233 will be described referring to FIGS. 5 to 8. The operating policy information may also be finely managed for every server, every logical volume, and the like, and may also be roughly managed for every tenant and every application. However, an example of a case where the operating policy is managed for every server and every logical volume will be described below.

FIG. 5 shows one example of a server rank table 500 which is a part of the operating policy information 233. The server rank table 500 is information for relating the server 203 and priority of the server which is described as a rank in FIG. 5 and is information prepared manually or according to any program beforehand. The server rank table 500 is provided with a server name field 501 and a rank field 502. The server rank table 500 may also be provided with a field not shown except these fields. In this example, a rank every virtual machine is held in such a manner that a rank of the VM_A1 is gold and a rank of the VM_A2 is silver.

FIG. 6 shows one example of a volume rank table 600 which is a part of the operating policy information 233. The volume rank table 600 is information for relating the logical volume 258 and priority of the logical volume which is described as a rank in FIG. 6 and is information prepared manually or according to any program beforehand. The volume rank table 600 is provided with a volume name field 601 and a rank field 602. The volume rank table 600 may also be provided with a field not shown except these fields.

FIG. 7 shows one example of a server rank detailed table 700 which is a part of the operating policy information 233. The server rank detailed table 700 is information for storing priority of a rank allocated to the server 203 and desired values of service levels provided at each rank and is information prepared manually or according to any program beforehand. The server rank detailed table 700 is provided with a priority field 701, a rank field 702, a response time field 703, and an RTO field 704. The server rank detailed table 700 may also lack some of these fields and may also be provided with a field not shown except these fields.

The priority field 701 shows priority in the rank and the rank field 702 includes identifiers for uniquely identifying specific rank. FIG. 7 shows that a platinum rank is the most important, a gold rank is next important and further, a silver rank is next important. Plural ranks 702 having the same Priority 701 may also exist.

The response time field 703 is a field storing desired values of response time. For example, 20 msec in the response time field tells that a service level that mean response time of requests to VM in the platinum rank is within 20 milliseconds is to be provided. When the management server 201 or the administrator of the computer system monitors response time of the server, the management server or the administrator determines that mean response time within 20 milliseconds does not matter as to the server in the platinum rank and judges that a problem occurs in the service level when mean response time exceeds 20 milliseconds.

The RTO field 704 is a field storing recovery objective time. For example, as RTO is five minutes in the case of the platinum rank, 5 min. in the RTO field tells the operating policy having such an objective that a problem is to be solved within five minutes since the occurrence of the problem that mean response time exceeds 20 milliseconds as to the server in the platinum rank.

FIG. 8 shows one example of a volume rank detailed table 800 which is a part of the operating policy information 233. The volume rank detailed table 800 stores priority of a rank allocated to the logical volume 258 and desired values of the service level provided in each rank, and includes information prepared manually or according to any program beforehand. The volume rank detailed table 800 is provided with a priority field 801, a rank field 802, a response time field 803, and an IOPS field 804. The volume rank detailed table 800 may also lack some of these fields and may also be provided with a field not shown except these fields.

Next, a problem solution process of the management computer 201 will be described. The problem solution process is executed by instructing the processor 211 to execute the problem solving program 220 stored in the management computer 201.

FIG. 9 is a flowchart showing an example of a procedure of the problem solution process 900 by the management server 201. First, a trigger when this flowchart is called will be described.

The problem solution process according to this flowchart may also be executed according to an instruction from the administrator input via the input device 214 of the management computer 201. In addition, the management server 201 may also be regularly executed, for example, every 5 minutes. Moreover, the problem solution process may also be executed when the management server 201 receives notice of problem occurrence transmitted by the computer system to be managed by the management server 201 via the network I/F 216.

As shown in FIG. 9, the management server 201 executes a problem detection step (a step S901), a cause location specification step (a step S902), a countermeasure procedure plan generation step (a step S903), a countermeasure procedure plan evaluation step (a step S904), a countermeasure procedure plan prioritization step (a step S905), a countermeasure procedure plan presentation step (a step S906), an administrator selection step (a step S907), and a countermeasure procedure plan execution step (a step S908). The problem solution process flow 900 may also include a step not shown except these steps and may also lack some of these steps.

In the problem detection step (the step S901), the management server 201 detects a problem caused in the computer system. For example, the management server 201 compares acquired resource activity ratio with a threshold of the resource activity ratio and detects that a problem occurs when the resource activity ratio exceeds the threshold. In addition, for example, the management server analyzes text of an acquired system log and detects that a problem occurs when a specific character string such as “error” and “warning” is included.

In the cause location specification step (the step S902), for example, when response time of the tenant A exceeds a threshold and extends, the management server checks operating situations of VM_A1, VM_A2, and the like configuring the computer system utilized by the tenant A referring to the topology correspondence table 400 shown in FIG. 4 and detects that response time of the logical volume becomes a bottleneck because of a cause that operating ratio of the DISK 254 of the storage 204 called ST1 is high.

When a location of a cause is input in the countermeasure procedure plan generation step (the step S903), the step S901 and the step S902 are not necessarily required to be executed if such alternative means that the administrator manually identifies the location of the cause is taken.

In the countermeasure procedure plan generation step (the step S903), the management server generates a countermeasure procedure plan for solving the problem in the location of the cause identified in the step S902. For examples of the countermeasure procedure plan, there can be given a procedure plan that the logical volume called VOL_A4 is to be migrated from the volume pool 3 to the volume pool 4 so as to reduce the activity ratio of the DISK 254, a procedure plan that the logical volume called VOL_A4 is to be migrated from the volume pool 3 to a volume pool 5, a procedure plan that an upper limit of IO to the VOL_A4 is to be limited to 50 IO per sec so as to reduce the activity ratio of the DISK 254, a procedure plan that the upper limit of IO to the VOL_A4 is to be limited from 50 IO per sec to 30 IO per sec so as to reduce the activity ratio of the DISK 254 and a procedure plan that a logical volume for replication is newly configured and a load of load reading requests is to be distributed. At this time, processing for reducing harmful influence on higher-ranking servers and logical volumes, compared with lower-ranking servers is executed referring to the operating policy 233. Details of the countermeasure procedure plan generation step (the step S903) will be described referring to FIG. 11.

In the countermeasure procedure plan evaluation step (the step S904), processing for simulating and evaluating effect of one or more countermeasure procedure plans generated in the step S903 is executed. For an example of the processing, processing for calculating influence and effect for every rank and evaluating plural types of procedure plans at the same criterion can be given. To evaluate procedure plans from a lateral viewpoint, effect, estimated execution time, and costs (for example, a required investment amount in a case of requiring addition of hardware) may also be evaluated in addition to influence. The countermeasure procedure plan evaluation step (the step S904) may also be executed as internal processing of the countermeasure procedure plan generation step (the step S903) for example and may also be substituted by receiving a value manually calculated by the administrator.

In the countermeasure procedure plan prioritization step (the step S905), the countermeasure procedure plans generated in the step S903 are eliminated or rearranged on the basis of a result evaluated in the step S904. For example, when the countermeasure procedure plan 1 is lower than the countermeasure procedure plan 2 in all items evaluated in the step S904, the countermeasure procedure plan 1 is eliminated from candidates presented to the administrator or is deleted from candidates automatically executed. When the countermeasure procedure plan 1 is evaluated in plural items, processing for evenly calculating overall evaluation results of the countermeasure procedure plans so as to prioritize in order in which evaluation results are better is executed. Details of the countermeasure procedure plan prioritization step (the step S905) will be described referring to FIG. 15.

In the countermeasure procedure plan presentation step (the step S906), processing for presenting the countermeasure procedure plans to the administrator of the computer system according to priority calculated in the step S905 via the output device 215 of the management server 201 or the output device 242 of the operation terminal 202 is executed. The step S906 is not necessarily required to be executed when it is preset that the uppermost countermeasure procedure plan in the overall evaluation of the countermeasure procedure plans calculated in the step S905 may be automatically executed, for example.

In the administrator selection step (the step S907), the countermeasure procedure plan selected by the administrator of the computer system is received via the input device 214 of the management server 201 or the input device 241 of the operation terminal 202. In the step S907, in addition to receiving the countermeasure procedure plan selected by the administrator, information for altering weighting of the overall evaluation in the step S905 may also be received. For an example of the information, to reduce an overall evaluation value of the countermeasure procedure plan having influence on the gold rank, information for altering a parameter so as to have negative influence on the overall evaluation in an item having influence on the gold rank can be given. When information for altering weighting of the overall evaluation is received, it is desirable that a branch for enabling return execution of the processing in the step S905 is provided.

In addition, in the step S907, information for altering the constraint may also be received. For example, information for eliminating such the constraint that harmful influence on SLO exceeds 60% even in the copper rank can be given. When information for altering the constraint is received, it is desirable that a branch enabling return execution of the step S903 is provided.

Moreover, in the step S907, when no information from the administrator is received for a fixed period or longer, a branch for enabling return execution of the process from the step S901 may also be provided. For example, in the case of a problem in performance, when 10 minutes or longer elapses, the problem is sometimes naturally solved and the problem is sometimes deteriorated. The abovementioned branch is a branch for proposing an optimum countermeasure in accordance with such a chance of a state.

In FIG. 9, a branch from the step S907 to the step S901 and a branch from the step S903 to the step S905 are shown. However, some of these branches may also be omitted and a branch not shown may also be included. In addition, it may also be determined that the administrator automatically selected the countermeasure procedure plan having the highest overall evaluation value, according to presetting that the countermeasure procedure plan having the highest overall evaluation value may also be automatically executed, for example.

In the countermeasure procedure plan execution step (the step S908), the countermeasure procedure plan selected in the step S907 is executed or the execution is registered. For example, when a countermeasure procedure for migrating the virtual machine is selected in the step S907, execution of Processing for migrating to a host machine is registered. The countermeasure procedure plan execution step (the step S908) is not necessarily required to be executed in a case where the management server 201 is provided with no function for executing a countermeasure procedure and the administrator manually operates the devices group to be managed. In addition, in the step S908, the countermeasure procedure plan selected by the administrator may also be stored as a result of execution. Details of processing in the case where the result of execution is stored in the step S908 will be described referring to FIG. 18.

FIG. 10 schematically shows an example of a procedure for the countermeasure procedure plan generation step (the step S903 in FIG. 9). The management server 201 generates a pattern 1001 of a constraint on the basis of the operating policy information 233 and generates a countermeasure procedure plan according to the constraint. As for the pattern 1001 of the constraint, an operator may also prepare the pattern on the basis of the operating policy information 233 and input the pattern to the management server 201.

In generating the pattern 1001 of the constraint, a range of influence is sorted. For example, the range of the influence is sorted for every gold, silver and copper rank. In addition, a degree of the influence is also sorted. For example, in a range deviating by 10% from a range in which influence on performance meets the SLO, the influence is sorted into a group of “small”, in a case deviating by 10 to 30% from the SLO, the influence is sorted into a group of “middle”, and in a case deviating by 30% or more from the SLO, the influence is sorted into a group of “large”. “-” means that the influence deviating from the SLO is unallowable.

Next, the pattern 1001 is generated under a constraint that the influence on the high order rank is below the influence on the low order rank. For an example of the pattern, such a pattern that gold is influenced by nothing, silver is slightly influenced and copper is moderately influenced and such a pattern that gold, silver and copper are all slightly influenced can be given. For example, such a pattern that gold is slightly influenced and silver and copper is influenced by nothing is excluded.

As for the countermeasure procedure plan according to the constraint, candidates to be operated are filtered according to the pattern 1001 of the constraint and an upper limit of operations is set. When an upper limit of 10 is set to virtual machines operated on the server 203 as a countermeasure for a problem that the network I/F 263 of the server 203 becomes a bottleneck, a list of the virtual machines operated on the server 203 where the problem occurs is acquired as the candidates 1002 to be operated.

In FIG. 10, it is supposed that VM_1, VM_2, VM_3 in a gold rank, VM_4, VM_5, VM_6 in a silver rank, and VM_7, VM_8, VM_9 in a copper rank are operated. In the case of filtering in consideration of such a constraint that gold and silver are influenced by nothing and copper is moderately influenced, virtual machines located in the gold and silver ranks are excluded from candidates to be operated and the upper limit of IO is set to the VM_7, the VM_8 and the VM_9 respectively located in the copper rank. In addition, since a constraint of influence on the copper rank is moderate, the upper limit of IO is set to a value lower by 30% than a value defined as the SLO. As described above, in the countermeasure procedure plan generation step (the step S903), the candidates 1002 to be operated are identified in the pattern 1001 of the generated one or more constraints so as to generate the countermeasure procedure plan.

FIG. 11 is a flowchart showing a procedure example of the countermeasure procedure plan generation step (the step S903) shown in FIG. 10. As shown in FIG. 11, the management server 201 executes an influence sorting step (a step S1101), a constraint pattern generation step (a step S1102), a step of acquiring candidates to be operated (a step S1103), a step of filtering the candidates to be operated (a step S1104), an operation upper limit setting step (a step S1105) and a countermeasure procedure plan generation step (S1106). A countermeasure procedure plan generation process flow 1100 may also include a step not shown except these steps and order of some steps may also be different.

In the influence sorting step (the step S1101), the management server 201 sorts a range of influence on the basis of the operating policy 233. For example, the management server sorts the range of the influence for every gold, silver, copper rank. In addition, the management server also sorts a degree of the influence. For example, the management server sorts a range having no influence on performance as S1, sorts a range deviating by 10% from a range in which the influence on performance meets the SLO as S2, sorts a range deviating by 10 to 20% from the SLO as S3, sorts an available range though the range deviates by 20% or more from the SLO as S4, and sorts an unavailable range as S5. Definition should be made in such a manner that an evaluation value decreases in ascending order of the influence. FIG. 12 shows an example in which a degree of the influence is sorted.

FIG. 12 show examples of an influence degree sort table 1200 generated in the influence sorting step (S1101) shown in FIG. 11. An influence degree sort table 1200A is provided with a sort field 1201, a service quality field 1202, and an evaluation value field 1203. The sort field 1201 uniquely identifies sorted performance. The service quality field 1202 shows a range of performance in the sort field 1201. The evaluation value field 1203 stores evaluation values allocated to the countermeasure procedure plan when effect and influence of the countermeasure procedure plan correspond to the sort field 1201. The influence degree sort table 1200A may also lack some of these fields and may also be provided with a field not shown. The influence degree sort table 1200 may also be stored in the main storage 212 and may also be stored in the auxiliary storage device 213 as a part of the operating policy information 233 for example.

An influence degree sort table 1200B shows another example of the table. A service quality field 1202 may also be defined independent of the SLO when no SLO is defined. The service quality field may also be sorted on the basis of a threshold of resource activity ratio when a degree of influence on resource activity ratio is sorted such as the activity ratio of the IO processing units of the storage. In addition, the administrator may also manually set the number of sorts and a range for every sort and the management server 201 may also generate the number of sorts and a range every sort by calculating them according to some processing.

FIG. 11 will be described again. In the constraint pattern generation step (the step S1102), the management server 201 generates such a pattern of a constraint that influence on the high order rank is below influence on the low order rank. For example, a pattern that gold is S1 not influenced, silver is S2 slightly influenced, and copper is S3 influenced to some extent when the influence is sorted as shown in FIG. 12, and a pattern that gold, silver and copper are also S2 slightly influenced can be given. A pattern that influence on gold is S3, silver and copper are not influenced for example is excluded. FIG. 13 shows an example of a generated pattern.

FIG. 13 shows one example of a constraint pattern table 1300 generated in the constraint pattern generation step (S1102) shown in FIG. 11. In this example, the constraint pattern table 1300 is provided with a Gold field 1301, a silver field 1302, and a copper field 1303. These fields have only to be generated on the basis of ranks defined in the operating policy 233. In FIG. 13, to make it visible that a range of the influence concentrates in the low order rank (the copper rank side), S1 not influenced is shown by a thin character. In the step S1101 and the step S1102, the results executed in advance may also be utilized. Since the operating policy is not frequently altered, the step S1101 and the step S1102 are executed at timing when the operating policy is first defined and at timing when the operating policy is altered for example, and the generated influence degree sort table 1200 and the generated constraint Pattern table 1300 may also be held.

The constraint pattern table 1300 may also be generated in such a great unit as the computer system and the tenant and may also be generated in a unit of the virtual machine and the storage as a part of them as shown in FIGS. 5 to 8. The constraint pattern table 1300 may also be stored in the main storage 212 and may also be stored in the auxiliary storage device 213 as a part of the operating policy information 233 for example.

FIG. 11 will be described again. In the step of acquiring candidates to be operated (the step S1103), the management server 201 acquires a list of candidates to be operated and also acquires rank information of the candidates to be operated. To acquire the list of candidates to be operated, the topology correspondence table shown in FIG. 4 for example may also be utilized. For a countermeasure for the problem that the network I/F 263 of the server 203 becomes a bottleneck, a case where an upper limit of 10 is set to the virtual machine operated on the server 203 will be described for an example below. In this case, all server names 402 having the same host machine name 403 in the topology correspondence table 400 shown in FIG. 4 as a name of the server in which the problem occurs are acquired. Next, rank information of the servers is acquired from the operating policy 233. For example, when the problem occurs in the host machine HV1 in FIG. 4, the VM_A1 and the VM_A1 are acquired as candidates to be operated and next, it is acquired from the server rank table 500 shown in FIG. 5 that the VM_A1 is located at a gold rank and the VM_A2 is located at a silver rank.

In the step of filtering candidates to be operated (the step S1104), candidates to be operated are filtered according to a pattern of the constraint. For example, gold and silver ranks are not influenced in the case of filtering on the basis of a pattern of the constraint shown on a first row of the constraint pattern table 1300 shown in FIG. 13, and therefore the gold and silver ranks are excluded from an object of operation. The gold rank is not influenced, the silver rank is influenced by S2, and the copper rank is influenced by S3 in the case of filtering on the basis of a pattern of the constraint shown on a second row of the constraint pattern table 1300 shown in FIG. 13 for example, so the gold rank is excluded from the object of operation.

In the step of setting an upper limit of operations (the step S1105), an upper limit of operations is set on the basis of the constraint. For example, influence on the silver rank is S2 when an upper limit of 10 of virtual machines in the countermeasure procedure plan is set on the basis of a second row in the constraint pattern table 1300 shown in FIG. 13, therefore the upper limit of IO is set to a value lower by 10% at the maximum from the SLO for virtual machines at the silver rank, and since influence on the copper rank is S3, the upper limit of IO is set to a value lower by 20% at the maximum from the SLO for virtual machines at the copper rank.

For example, when such a countermeasure procedure plan that the virtual machine is migrated to an external host machine on the constraint on the second row in the constraint pattern table 1300 shown in FIG. 13 until a bottleneck of the original host machine is solved is generated, such a constraint that a frequency selected as an object of migration is 0:1:2 for gold:silver:copper is given. Concretely, the solution of the bottleneck can be realized by such migration that once per three times, both the silver rank and the copper rank become a candidate of the object of migration and twice per three times, only the copper rank becomes a candidate of the object of migration.

In the countermeasure procedure plan generation step (the step S1106), a countermeasure procedure plan is generated according to the list of the candidates to be operated generated in the step S1104 and the upper limit generated in the step S1105. The countermeasure procedure plan itself has only to be generated using well-known technique.

The steps S1104, S1105, 51106 may also be repeated in all the patterns generated in the step S1102 and may also be repeated only in one or some of the patterns generated in the step S1102.

FIG. 14 shows one example of a countermeasure procedure plan evaluation result table 1400 generated in the countermeasure procedure plan evaluation step (S904) shown in FIG. 9. The countermeasure procedure plan evaluation result table 1400 is provided with a countermeasure procedure plan ID field 1401, an influence field 1402, an effect field 1403, an execution results field 1404 and a cost field 1405. The countermeasure procedure plan evaluation result table 1400 may also lack some of these fields and may also be provided with a field not shown except these fields.

The countermeasure procedure plan ID field 1401 stores identifiers for uniquely identifying countermeasure procedure plans. The influence field 1402 stores evaluation results of influence of the simulated countermeasure procedure plans. The influence field 1402 may also be evaluated in a state subdivided every rank as shown in FIG. 14 and may not be subdivided. The effect field 1403 stores evaluation results of effect of the simulated measure procedure plans. The effect field 1403 may also be evaluated in a state subdivided every rank as shown in FIG. 14 and may not be subdivided. The execution results field 1404 stores evaluation values of execution results of the countermeasure procedure plans. The cost field 1405 stores respective evaluation values of a sum for purchasing additional hardware, a sum for contract required for a virtual machine newly configured for a countermeasure for a scale out, and a sum required to execute the countermeasure procedure plan, for example. FIG. 14 shows that the larger evaluation values in any item are, the better the countermeasure procedure plans are.

The evaluation result table 1400 may also be generated in such a large unit as the computer system and the tenant and may also be generated in such a unit as the virtual machine and the storage as a part of the computer system as shown in FIGS. 5 to 8. The countermeasure procedure plan evaluation result table 1400 may also be stored in the main storage 212 and may also be stored in the auxiliary storage device 213 as a part of the operating policy information 233 for example. FIG. 15 is a flowchart showing details of the countermeasure procedure plan prioritization step (the step S905). As shown in FIG. 15, the management server 201 executes an elimination step (a step S1501), an overall evaluation value calculation step (a step S1502), and a rearrangement step (a step S1503). A countermeasure procedure plan prioritization process flow 1500 may also include a step not shown except these and may also lack some steps. In the countermeasure procedure plan prioritization process flow 1500, order of these steps may also be altered.

In the elimination step (the step S1501), all evaluation values in the specific countermeasure procedure plan are compared with evaluation values in the other countermeasure procedure plans in all items, and when all the evaluation values in the specific countermeasure procedure plan are smaller in all the items or when some of evaluation values are the same and the other evaluation values are smaller, that is, when no superior evaluation value in any item exists, elimination is made.

For example, when the countermeasure procedure plan having countermeasure procedure plan ID of 2 and the countermeasure procedure plan having countermeasure procedure plan ID of 4 are compared in FIG. 14, a value in a Gold rank of the influence field 1402 of the countermeasure procedure plan 4 is smaller than the countermeasure procedure plan having the countermeasure procedure plan ID of 2, and evaluation values in the other items are the same. Therefore, the countermeasure procedure plan having the countermeasure procedure plan ID of 4 is eliminated. In addition, the countermeasure procedure plan having countermeasure procedure plan ID of 3 is compared with the countermeasure procedure plan having the countermeasure procedure plan ID of 2, and since evaluation values in all items are smaller, the countermeasure procedure plan having the countermeasure procedure plan ID of 3 is eliminated. In the meantime, when the countermeasure procedure plan having countermeasure procedure plan ID of 1 is compared with the countermeasure procedure plan having the countermeasure procedure plan ID of 2, the countermeasure procedure plan having the countermeasure procedure plan ID of 1 is superior in a silver item of the influence field 1402 and the countermeasure procedure plan having the countermeasure procedure plan ID of 2 is superior in the gold item of the influence filed 1403. As described above, the countermeasure procedure plan having the superior evaluation value in any item is not eliminated. FIG. 16 shows an outline of elimination.

FIG. 16 shows the outline of elimination when evaluation results of the countermeasure procedure plans are as shown in FIG. 14. The explanation is given above.

In the overall evaluation value calculation step (the step S1502), overall evaluation values of the countermeasure procedure plans are calculated. In the evaluation results of the countermeasure procedure plans shown in FIG. 14, the countermeasure procedure plans are evaluated from viewpoints of influence, effect, execution results, and costs.

FIG. 17 shows one example of an expression for calculating an overall evaluation value used in the overall evaluation value calculation step (S1502) shown in FIG. 15. To prioritize in consideration of all these evaluation values, an overall evaluation value is calculated by calculating the sum of values acquired by multiplying respective evaluation values by a constant (A, B, C, D in FIG. 17) as in the expression shown in FIG. 17, for example. The constants for multiplying the respective evaluation values may also be values arbitrarily set by the administrator and may also be arbitrary values calculated by the management server 201.

In the rearrangement step (the step S1503), overall evaluation values calculated in the step S1502 are rearranged in descending order. By this processing, the countermeasure procedures shown in FIG. 14, for example, are evaluated and rearranged on the basis of the mathematical expression shown in FIG. 17.

FIG. 9 will be described again. A list of the countermeasure procedures shown in FIG. 14 which are rearranged in order of evaluation points is acquired by the countermeasure procedure plan prioritization step (S905). In the example shown in FIG. 9, a result is presented by the countermeasure procedure plan presentation step (S906). In the administrator selection step (S907), the administrator selects the desired plan out of the countermeasure procedure plans and the selected countermeasure procedure is executed in the countermeasure procedure plan execution step (S908). The countermeasure procedure plan presentation step (S906) and the followings are omitted and the process may also be once finished after the countermeasure procedure plan is held as data.

### Second Embodiment

The first embodiment enables the administrator to select candidates prioritized in the countermeasure procedure plan prioritization step (S905). However, since work for selecting out of candidates requires a fixed skill, it is desirable that the selection is supported in the system. In a second embodiment, an example that when an administrator selects a candidate, selection of a proper candidate can be assisted will be described.

The second embodiment is based upon the configuration of the first embodiment and the following configuration has only to be added.

FIG. 18 is a flowchart showing an example of a procedure for a countermeasure procedure plan execution step (a step S908) when execution results of countermeasure procedure plans executed by the management server 201 are stored and in this case, the flowchart is called a learning process flow 1800. In the first embodiment, in the countermeasure procedure plan execution step (the step S908), the selected procedure is executed and execution results are merely counted. However, in the second embodiment, a management server 201 evaluates execution results for every pattern of evaluation of a countermeasure procedure plan selected by an administrator. Accordingly, execution results of different types of countermeasure procedure plans are also reflected in execution results as the same pattern if only patterns of evaluation are the same. In this embodiment, processing for increasing an evaluation value of an execution result is described as storing processing or “store” and processing for decreasing an evaluation value of an execution result is described as obliterating processing or “obliterate”.

A pattern of evaluation of a countermeasure procedure plan can be arbitrarily defined by an administrator and a user. For example, a pattern of evaluation can be represented by numeric values for every rank as in such a pattern that influence on gold is 5, influence on silver is 4 and influence on silver is 1 or such a pattern that influence on gold is 4, influence on silver is 3, and influence on silver is 2. In addition, such a condition that only 2 or more influence is brought to all gold, silver and copper ranks, such a condition that only 3 or more effect is brought to all the gold, silver and copper ranks and such a condition that only 2 or more influence is brought to all the gold, silver and copper ranks and only 3 or more effect is brought to all the gold, silver and copper ranks may also be set.

As shown in FIG. 18, the management server 201 executes a role acquisition step (a step S1801), a variable acquisition step (a step S1802), a selected pattern storing step (a step S1803), an unselected pattern obliterating step (a step S1804), and an execution registering step (a step S1805).

In the role acquisition step (the step S1801), the management server acquires a role of an administrator who selects a countermeasure procedure plan. For example, such information that the administrator is an expert role having a high system management skill and such information that the administrator is a general role having only a low skill are acquired.

In the variable acquisition step (the step S1802), a storage variable 1902 and an obliteration variable 1903 on a row corresponding to the role acquired in the step S1801 are acquired from a variable table 1900.

FIG. 19 shows one example of the variable table 1900. The variable table 1900 holds variables utilized in processing for learning execution results executed in the steps S1803 and S1804 and includes information prepared manually or according to any program beforehand. The variable table 1900 is provided with a role field 1901, a storage variable field 1902, and an obliteration variable field 1903. The variable table 1900 may also lack some of these fields and may also be provided with another field not shown. The role field 1901 is an identifier for uniquely identifying the role of the administrator.

FIG. 18 will be described again. In the selected pattern storing step (the step S1803), the management server stores a pattern of evaluation of the selected countermeasure procedure plan. For example, the storage can be realized by adding a fixed value to a value of the existing execution results. For example, when the pattern of the countermeasure procedure plan selected according to the administrator role is stored, a value of 5 is acquired from the storage variable field 1902 of the variable table 1900 in the step S1802 and the value of 5 is added to execution results of the pattern corresponding to the countermeasure procedure plan selected by the administrator. The corresponding pattern is not required to be limited to one and plural patterns may also correspond.

In the unselected pattern obliterating step (the step S1804), the management server obliterates a pattern of evaluation of an unselected countermeasure procedure plan. For example, the obliteration can be realized by multiplying an evaluation value of the existing execution results by a numeric value of 0 to below 1. For example, when a pattern of evaluation of a countermeasure procedure plan not selected in the administrator role field is obliterated, a numeric value of 0.6 is acquired from the obliteration variable field 1903 of the variable table 1900 in the step S1802 and values of execution results of all patterns not selected by the administrator are multiplied by the value of 0.6.

Similarly, as for patterns of evaluation of countermeasure procedure plans selected as a general role, the similar processing is executed using the storage variable 1902 and the obliteration variable 1903 respectively corresponding to the general role. Owing to the storing step (S1803) and the obliterating step (S1804), evaluation patterns of countermeasure procedure plans considered empirically proper can be weighted.

In the execution registering step (S1805), execution of the countermeasure procedure plan selected by the administrator is registered.

FIG. 20 shows one example of a pattern table 2000. The Pattern table 2000 is a table for managing execution results for every pattern of evaluation of the countermeasure procedure plan selected by the administrator, the pattern table is generated only when the administrator selects the countermeasure procedure plan for the first time, and execution results as to only patterns selected by the administrator have only to be held. Or execution results may also be held as to patterns of all evaluation results of countermeasure procedure plans generated by the management server.

The pattern table 2000 is provided with a pattern ID field 2001, an influence field 2002, an effect field 2003, a cost field 2004, and an execution result field 2005. For an example of a pattern showing numeric values every rank, the pattern table 2000 basically has only to be provided with the similar fields to the countermeasure procedure plan evaluation result table 1400. However, the pattern table may also lack some of these fields, and may also be provided with a field not shown such as an evaluation field for storing values evaluating a situation in which a problem occurs.

The management server 201 compares the table 1400 and the table 2000 in the countermeasure procedure plan evaluating step (the step S904) in calculating evaluation values of an execution result of a countermeasure procedure plan. For one example, the management server calculates a value in the execution result field 2005 having a coincident value in the countermeasure procedure plan influence field 1402 and the influence field 2002, having a coincident value in the effect field 1403 and the effect field 2003, and having a coincident value in the cost field 1405 and the cost field 2004 as a value of the execution result 1404. Or the management server may also calculate a value in the execution result field 2005 having a coincident value in the countermeasure procedure plan influence field 1402 and the influence field 2002, and having a coincident value in the effect field 1403 and the effect field 2003 as a value of the execution result 1404. Or the management server may also calculate a value in the execution result field 2005 having a coincident value in the countermeasure procedure plan influence field 1402 and the influence field 2002 as a value of the execution result 1404.

When no execution result of a pattern coincident with evaluation results of the countermeasure procedure plan exists, an arbitrary value such as 0 has only to be input for an evaluation value of the execution result 1404.

FIG. 21 shows variation of values in the execution result field 2005 when the storing step and the obliterating step are executed in a case where a user of the administrator role selects a countermeasure procedure plan having pattern ID of 1. A predetermined value is added as weight of the selected pattern and weight of unselected patterns is reduced at the same rate.

In the learning process flow 1800, both the storing step (the step S1803) and the obliterating step (the step S1804) are executed. However, only one of them is executed, and the other may also be not executed. In addition, the storing step (the step S1803) and the obliterating step (the step S1804) may also be executed in inverse order. Moreover, when the role of the administrator is not considered, the steps S1801 and S1802 are not necessarily executed and the storage variable 1902 and the obliteration variable 1903 respectively being constantly a fixed value may also be continued to be utilized in a learning process. The variable table 1900 and the pattern table 2000 may also be stored in a main storage 212 and may also be stored in an auxiliary storage device 213.

In the countermeasure procedure plan execution step (S908) in the second embodiment, the patterns 2000 of evaluation of countermeasure procedure plans are weighted by learning circumstances in selecting past candidates as described above.

Accordingly, in the second embodiment, a candidate having the same pattern as a pattern having a predetermined value or more (for example, 5 or more) in an execution result value can be highlighted utilizing the abovementioned information in a countermeasure procedure plan presentation step (S906) shown in FIG. 9 for example. Hereby, the administrator can know a trend in selecting past countermeasure procedure plan candidates.

For another example, the abovementioned weighting is reflected in values in the execution result field 1404 of the countermeasure procedure plan evaluation result table 1400 shown in FIG. 14 in the first embodiment, the reflected values are evaluated on the basis of a mathematical expression shown in FIG. 17 in an overall evaluation value calculation step (S1502) shown in FIG. 15, and the evaluated values are rearranged. In this case, prioritization in which past select patterns are reflected is acquired. For a method of reflecting weighting in the values in the execution result field 1404, a method of operating (adding the execution results 2005 of the pattern ID 2001 of the same pattern to the countermeasure procedure plan execution results 1404 or multiplying the countermeasure procedure plan execution results 1404 by the execution results 2005) and acquiring execution results 1404 in which weighting is reflected can be given.

In addition, in the second embodiment, since a difference per pattern among values in the execution result field 2005 of the countermeasure procedure plan evaluation patterns shown in FIG. 21 increases, a countermeasure procedure plan having the same pattern as an evaluation pattern having a fixed value or less it may also be eliminated.

The present invention is not limited to the abovementioned embodiments, and various variations and the similar configurations in the purport of attached claims are included. For example, the abovementioned embodiments are detailed description for clarifying the present invention and the present invention is not necessarily limited to the described all configurations. In addition, a part of the configuration in a certain embodiment may also be replaced with the configuration in another embodiment. Moreover, the configuration in another embodiment may also be added to the configuration in a certain embodiment. In addition, as for a part of the configuration in each embodiment, another configuration may also be added, deleted, or replaced.

Further, a part or the whole of each of the abovementioned configurations, functions, processors, and processing devices may also be realized by hardware by designing it by an integrated circuit and the like, and a part or the whole may also be realized by software by interpreting and executing a program respective functions of which are realized by the processor.

Information such as a program for realizing each function, a table and a file can be stored in the storage such as a memory, a hard disk and an SSD (Solid State Drive) or on the record medium such as an IC card, an SD card, DVD, a blue ray disk and another optical disk.

Furthermore, only the control lines and the information lines respectively considered necessary for description are shown, and all the control lines and the information lines respectively required for packaging are not shown. Actually, it may be considered that substantially all the configurations are mutually connected.

### INDUSTRIAL APPLICABILITY

The present invention can be utilized for operation management of a computer system.

### LIST OF REFERENCE SIGNS

201: Management server, 211: Processor, 212: Main storage, 213: Auxiliary storage device, 220: Problem solution process, 2131: Constraint

1. A management computer provided with a processor, an input device, an output device, and a storage for managing a plurality of computer systems, comprising:
a countermeasure procedure plan generation module for generating countermeasure procedure plans for altering states of parts in the plurality of computer systems,
wherein the countermeasure procedure plan generation module generates the countermeasure procedure plans according to a constraint that influence on a higher-ranking computer system or its part out of the plurality of computer systems or their parts is to be smaller than influence on a lower-ranking computer system or its part.

2. The management computer according to claim 1,
wherein the countermeasure procedure plan generation module is provided with a filtering module that alters a state of a part in the higher-ranking computer system and eliminates, from the generated countermeasure procedure plans, a countermeasure procedure plan in which a state of a part in the lower-ranking computer system is unaltered.

3. The management computer according to claim 1,
wherein the constraint includes information defining quality to be met by the computer system or its part as a quality class and correlating the quality class for each of the computer systems or their parts, and
the countermeasure procedure plan generation module generates the plurality of countermeasure procedure plans such that the quality class is met.

4. The management computer according to claim 1, further comprising:
a countermeasure procedure plan evaluation module that simulates and evaluates effect of one or more countermeasure procedure plans generated by the countermeasure procedure plan generation module; and
a countermeasure procedure plan prioritization module that prioritizes the one or more countermeasure procedure plans on the basis of evaluation results by the countermeasure procedure plan evaluation module.

5. The management computer according to claim 4,
wherein the countermeasure procedure plan evaluation module generates countermeasure procedure plan evaluation result information correlating countermeasure procedure plan IDs for identifying the one or more countermeasure procedure plans and evaluation values of at least one of effect and influence on the plurality of computer systems or their parts in a high order rank and a low order rank for every countermeasure procedure plan ID,
the evaluation result information includes evaluation result information of at least a first countermeasure procedure plan and a second countermeasure procedure plan, and
the countermeasure procedure plan prioritization module eliminates the first countermeasure procedure plan from the countermeasure procedure plans (1) when all evaluation values of the first countermeasure procedure plan are below those of the second countermeasure procedure plan in the evaluation result information or (2) when some of evaluation values of the first countermeasure procedure plan are below those of the second countermeasure procedure plan and the other evaluation values of the first countermeasure procedure plan have the same values as those of the second countermeasure procedure plan in the evaluation result information.

6. The management computer according to claim 4,
wherein the countermeasure procedure plan evaluation module generates countermeasure procedure plan evaluation result information correlating countermeasure procedure plan IDs for identifying one or more countermeasure procedure plans and evaluation values of at least one of effect, influence, an execution result and a cost on the plurality of computer systems or their parts in a high order rank and a low order rank for every countermeasure procedure plan ID, and
the countermeasure procedure plan prioritization module acquires overall evaluation values by performing predetermined operation on the basis of the evaluation values and rearranges the one or more countermeasure procedure plans on the basis of the overall evaluation values.

7. The management computer according to claim 4, further comprising:
a countermeasure procedure plan presentation module;
a select module; and
a countermeasure procedure plan execution module,
wherein the countermeasure procedure plan evaluation module generates countermeasure procedure plan evaluation result information correlating countermeasure procedure plan IDs for identifying the one or more countermeasure procedure plans and evaluation values of at least one of effect and influence on the plurality of computer systems or their parts in the high order rank and the low order rank for every countermeasure procedure plan ID,
the countermeasure procedure plan presentation module presents the evaluation result information,
the select module instructs an operator to select one or a plurality of countermeasure procedure plans on the basis of the presented evaluation result information,
the countermeasure procedure plan execution module manages pattern information correlating evaluation values of at least one of effect and influence on the plurality of computer systems or their parts in the high order rank and the low order rank and execution results for every pattern ID, and
the countermeasure procedure plan execution module performs at least one of addition and weighting to the execution result in the pattern information having predetermined relation to evaluation result information of the countermeasure procedure plan selected in the select module.

8. The management computer according to claim 7,
wherein the countermeasure procedure plan execution module manages the execution results by increasing a value of the execution result in the pattern information having the same pattern as the evaluation result information of the countermeasure procedure plan selected in the select module and by decreasing values of execution results of unselected patterns.

9. A computer system management method of managing a plurality of computer systems by a management computer provided with a processor, an input device, an output device, and a storage, comprising a step of:
generating a countermeasure procedure plan according to a constraint that influence on a higher-ranking computer system or its part out of the plurality of computer systems or their parts is to be smaller than influence on a lower-ranking computer system or its part when the management computer generates the countermeasure procedure plan for altering states of parts in the plurality of computer systems.

10. The computer system management method according to claim 9,
wherein the management computer executes filtering processing for altering a state of a part in the higher-ranking computer system and eliminating, from the generated countermeasure procedure plans, a countermeasure procedure plan in which a state of a part of the lower-ranking computer system is unaltered.

11. The computer system management method according to claim 9,
wherein the constraint includes information defining quality to be met by the computer system or its part as a quality class and correlating the quality class for each of the computer systems or their parts, and
the management computer generates the plurality of countermeasure procedure plans such that the quality class is met.

12. The computer system management method according to claim 9,
wherein the management computer executes:
evaluation processing for simulating and evaluating effect of one or more countermeasure procedure plans; and
prioritization processing for prioritizing the one or more countermeasure procedure plans on the basis of evaluation results.

13. The computer system management method according to claim 12,
wherein the evaluation processing generates countermeasure procedure plan evaluation result information correlating countermeasure procedure plan IDs for identifying one or more countermeasure procedure plans and evaluation values of at least one of effect and influence on the plurality of computer systems or their parts in a high order rank and a low order rank for every countermeasure procedure plan ID,
the evaluation result information includes evaluation result information of at least a first countermeasure procedure plan and a second procedure plan, and
in the prioritization processing, the first countermeasure procedure plan is eliminated from the countermeasure procedure plans (1) when all evaluation values of the first countermeasure procedure plan are below those of the second countermeasure procedure plan in the evaluation result information or (2) when some of evaluation values of the first countermeasure procedure plan are below those of the second countermeasure procedure plan and the other evaluation values of the first countermeasure procedure plan have the same values as those of the second countermeasure procedure plan in the evaluation result information.

14. The computer system management method according to claim 12,
wherein the evaluation processing generates countermeasure procedure plan evaluation result information correlating countermeasure procedure plan IDs for identifying one or more countermeasure procedure plans and evaluation values of at least one of effect, influence, an execution result and a cost on the plurality of computer systems or their parts in a high order rank and a low order rank for every countermeasure procedure plan ID, and
in the prioritization processing, overall evaluation values are acquired by performing predetermined operation on the basis of the evaluation values and the one or more countermeasure procedure plans are rearranged on the basis of the overall evaluation values.

15. The computer system management method according to claim 12,
wherein the management computer further executes countermeasure procedure plan presentation processing, selection processing and countermeasure procedure plan execution processing,
the evaluation processing generates countermeasure procedure plan evaluation result information correlating countermeasure procedure plan IDs for identifying the one or more countermeasure procedure plans and evaluation values of at least one of effect and influence on the plurality of computer systems or their parts in the high order rank and the low order rank for every countermeasure procedure plan ID,
in the countermeasure procedure plan presentation processing, the evaluation result information is presented,
in the selection processing, an operator is instructed to select one or a plurality of countermeasure procedure plans on the basis of the presented evaluation result information,
the countermeasure procedure plan execution processing manages pattern information correlating evaluation values of at least one of effect and influence on the plurality of computer systems or their parts in the high order rank and the low order rank and execution results for every pattern ID, and
a value of the execution result in the pattern information having predetermined relation to the evaluation result information of the countermeasure procedure plan selected in the select module is increased and values of the other execution results in the pattern information are decreased.
